(19) United States
(12) Patent Application Publication
(10) Pub. No.: US 2012/0107579 A1
(43) Pub. Date: May 3, 2012

(54) INK COMPOSITION

(76) Inventors: Yaron Grinwald, Moitar (IL); Peretz Ben-Avraham, Rehovot (IL); Eyal Bechar, Modl'in (IL); Yigal Berson, Lod (IL); Stella Stolin Roditi, Rohovot (IL); Merav Shapira, Yavne (IL); Peter Forgacs, Givon Hamadasha (IL); Albert Teishev, Rishon le-Zion (IL)

(21) Appl. No.: 13/382,518

(22) PCT Filed: Jul. 7, 2009
(86) PCT No.: PCT/EP2009/058576

§ 371 Date: Jan. 5, 2012

(51) Int. Cl. B32B 3/00; B02C 19/00; B41J 2/015; C09D 11/10

(52) U.S. Cl. 428/195.1; 524/522; 241/25; 347/20

(57) ABSTRACT

An ink composition having a viscosity which is below about 50.0 cps and having, at least, 10 wt %, by total weight of ink composition, of non volatile substances. Said composition comprising a carrier liquid, a dispersing agent, and solid particles; said solid particles are dispersed in the carrier liquid and comprise pigments embedded with resin polymers.

### BACKGROUND OF THE INVENTION

Inkjet processes have the inherent potential to be simpler, less costly, and more reliable than digital electro-photographic processes. Inkjet printing systems involve ejecting ink droplets from orifices in a print head onto a receiving substrate (media) to form an image. Inkjet printing systems commonly utilize direct printing architecture or, sometimes, can utilized indirect inkjet printing architecture. In direct printing-system, the ink is ejected from jets in the print head directly onto the final receiving media. In indirect inkjet printing, the ink is ejected onto an intermediate transfer member rather than directly onto the media.

In inkjet printing systems, aqueous inks or non-aqueous inks, comprising pigments and polymers which are not chemically bounded to each other, are often employed. When inkjet process prints directly on media, aqueous inks, using water as a main solvent, are often used. Such technique has the disadvantage that, during the printing process, an important amount of the liquid ink carrier (usually water) is absorbed by the media fibers which often involves a process to drive out water from paper fibers. This drying process limits thus the process speed of inkjet device and could adversely affect the appearance of the printing. Furthermore, the absence of pigment polymer binding is reflected in smearing problems, low optical density and low durability of ink on media. Moreover, the quality of aqueous-based ink jet image is strongly dependent upon the properties of the surface media.

Indirect inkjet printing is a technique wherein ink droplets are ejected onto an intermediate transfer member rather than directly onto the media. The ink image is thus dried on the intermediate transfer member (blanket) and is then transferred to the media. In order to facilitate the drying of the volatile part of the ink, an oil based formulation rather than water based formulation is often used, due, mainly, to the lower overall energy of evaporation. Such indirect transfer technique helps also in offering compatibility with various types of media.

### BRIEF DESCRIPTION OF THE DRAWINGS

In order to better understand the present disclosure, some embodiments will be described below by way of non-limiting examples only, with reverence to figures, wherein:

FIG. 1 is a graph representing the correlation between the addition of dispersing agent and the viscosity of the ink composition according to one embodiment of the present invention.

FIG. 2 is a graph representing the correlation between the amount of NVS, the addition of dispersing agent and the viscosity of the ink composition according to one embodiment of the present invention.

### DETAILED DESCRIPTION

Embodiments of the present disclosure will employ, unless otherwise indicated, techniques of synthetic organic chemistry, ink chemistry, media chemistry, printing chemistry, and the like, that are within the skill of the art. Such techniques are explained fully in the literature. The following examples are put forth to provide those of ordinary skill in the art with a complete disclosure and description of how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in ° C., and pressure is at or near atmospheric. Standard temperature and pressure are defined as 20° C. and 1 atmosphere. Unless otherwise indicated, the viscosity is measured at a shear rate of 11 l/sec and is expressed in cps and is measured at a temperature of 25° C.

Before the embodiments of the present disclosure are described in detail, it is to be understood that, unless otherwise indicated, the present disclosure is not limited to particular materials, and processes disclosed herein as such may vary to some degree. It is also to be understood that the terminology used herein is for purposes of describing particular embodiments only, and is not intended to be limiting, as the scope of the present invention will be defined only by the appended claims and equivalents thereof.

In the present specification, and in the appended claims, the following terminology will be used: the singular forms “a”, “an”, and “the” include plural referents unless the context clearly dictates otherwise. Thus, for example, reference to “a support” includes a plurality of supports. The terms “about” and “approximately,” when referring to a numerical value or range is intended to encompass the values resulting from experimental error that can occur when taking measurements. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of approximately 1 wt % to approximately 20 wt % should be interpreted to include not only the explicitly recited concentration limits of 1 wt % to approximately 20 wt %, but also to include individual concentrations such as 2 wt %, 3 wt %, 4 wt %, and sub-ranges such as 5 wt % to 15 wt %, 10 wt % to 20 wt %, etc. Unless indicated otherwise, the percentage (%) of components expresses the weight percentage (wt %) of components.

In an embodiment of the present invention, the ink composition has a viscosity which is below 50.0 cps, when measured at 25° C., and has, at least, 10 wt % of total weight of ink composition of non volatile substances (NVS). The ink composition comprises a carrier liquid, a dispersing agent, and solid particles. Such solid particles are dispersed in the carrier liquid and comprise pigments embedded with resin polymers. In an embodiment, the solid particles, present in the ink composition, are dispersed in the carrier liquid and are resin particles impregnated with pigments. It is believed that that it is with this specific combination that the composition has its specific properties: good jettability and good printing performances.

In an embodiment, the present disclosure provides ink compositions suitable, especially, for indirect inkjet printing that have specific characteristics, such as low viscosity, submicron particle size range, encapsulation of the pigment in the binder system, and that have good printing qualities. Thus, in an embodiment, the ink compositions is an inkjet ink composition; in another embodiment, the ink compositions is a non-aqueous inkjet ink composition; in another embodiment, the ink compositions is a non-aqueous inkjet ink composition well adapted for indirect inkjet printing system.

In an embodiment, the present disclosure provides inks composition which have adequate viscosity in view of not affecting printing performances, and which have, in the same time, high concentration of solid pigmented material in view of producing the highest image densities and good image durability.

In an embodiment of the present invention, the ink composition has a viscosity within the range of from about 1.0 to about 50.0 cps, in another embodiment, within the range of from about 5.0 to about 25.0 cps, and, in another embodiment, within the range of from about 10.0 to about 20.0 cps, when measured at 25° C., in order to achieve the desired rheological characteristics. In an embodiment, the viscosity of the ink composition might be conveniently regulated, as known to those of ordinary skill in the art, for instance, by suitable use of other additives.

A benefit of the composition according to an embodiment of the invention, is to have a highly concentrated ink, i.e. ink that contains a high level of non volatile substances (in an embodiment, more than 10%), in the same time with a low viscosity (below 50.0 cps) and without having any adverse effect on particle distribution. It is believed that such high level of non volatile substances and thus of, solid particles containing colored resin, has the benefit of generating inks which have good durability on media and which generate printed images with good optical density.

In an embodiment of the present invention, the ink composition is an inkjet ink printing composition. By inkjet composition, it is meant herein that the composition is very well adapted to be used in an inkjet device and in an inkjet printing process, in other word, the ink composition is suitable for inkjet ink printing. In another embodiment of the present invention, the ink composition is an inkjet ink composition very well adapted to be used in an indirect printing system, i.e. in a system wherein the print head of the printing device jets the ink onto an intermediate transfer surface.

In an embodiment of the present invention, the ink composition has weight percentage of non volatile substances which is more than 10% of total weight of ink composition. In another embodiment, the ink composition has weight percentage of non volatile substances which is more than 15% of total weight of ink composition. In another embodiment, the ink composition has weight percentage of non volatile substances which is more than 20% of total weight of ink composition.

As used herein, the percentage of non volatile substances (NVS) represents the percentage of solid ingredient present in the formulation. In other word, it represents the total amount of solid ingredients and/or components that remain in the composition once the volatile substance is evaporated, in this specific case when the carrier liquid is evaporated. The percentage of non volatile substances (% NVS), represents, also, the amount of ingredients that will remain on the surface of the media when the volatile substance, i.e. the liquid carrier, will be evaporated. In an embodiment, the non volatile substances (NVS) comprise the pigment embedded in resin polymer and the dispersing agent.

In an embodiment of the present invention, the dispersing agents represent from about 0.5 wt % to about 40 wt % of total weight of non volatile substances; in another embodiment, the dispersing agents represent from about 1 wt % to about 25 wt % of total weight of non volatile substances present in the ink composition and, in another embodiment, the dispersing agents represent from about 5 wt % to about 20 wt % of total weight of non volatile substances present in the ink composition.

In an embodiment of the present invention, the solid particles represent from about 60 wt % to about 99.5 wt % of total weigh weight of non volatile substances; in another embodiment, the solid particles represent from about 75 wt % to about 99 wt % of total weight of non volatile substances and, in another embodiment, the solid particles represent from about 80 wt % to about 95 wt % of total weight of non volatile substances present in the ink composition.

The ink composition comprises a carrier liquid. Different carriers liquid are possible and may include, in different embodiments, non-aqueous liquid carrier fluids or oil-based carrier fluids. In one embodiment, the carrier liquid is a non-aqueous carrier liquid. In one embodiment, non-limiting examples of non-aqueous carrier include alcohol. In an embodiment, a suitable non-aqueous carrier fluid is entirely void of water. In another embodiment, a suitable non-aqueous carrier fluid may include water in an amount of less than 5% and, in another embodiment, in an amount of less than 1% water. In another embodiment, the carrier liquid is an oil-based carrier liquid. In one embodiment, non-limiting example of oil-based carrier is Isopar-L® (available from Exxon-Mobil Corporation). Such non-aqueous liquid carrier fluids and oil-based carrier fluids have the benefits of being carrier liquid which evaporate easily from the intermediate transfer surface.

In an embodiment, the carrier liquid is present in an amount of from about 40 wt % to about 90 wt % by total weight of the ink composition. In another embodiment, the carrier liquid is present in an amount of from about 50 wt % to about 85 wt % by total weight of the ink composition. In another embodiment, the carrier liquid is present in an amount of from about 60% to about 80% by total weight of the ink composition.

The carrier liquid includes, but is not limited to, hydrocarbons, halogenated hydrocarbons, cyclic hydrocarbons, functionalized hydrocarbons (where functionalized can include alcohols, acids, esters, ethers, sulfonic acids, sulfonic acid esters, and the like). In another embodiment, the liquid carrier is silicone oil. In one embodiment, example of silicone oil includes dimethylsiloxanes. The hydrocarbon includes, but is not limited to, an aliphatic hydrocarbon, an isomerized aliphatic hydrocarbon, branched chain aliphatic hydrocarbons, aromatic hydrocarbons, and combinations thereof. Illustrative carrier liquids include, but are not limited to, aliphatic hydrocarbon, isoparaffinic compounds, paraffinic compounds, de-aromatized hydrocarbon compounds, and the like. In one embodiment, the carrier liquids include, but are not limited to, Isopar-G®, Isopar-H®, Isopar-L®, Isopar-M®, Isopar-K®, Isopar-V®, Norpar 12®, Norpar 13®, Norpar 15°, Exxol D40®, Exxol D80®, Exxol D100®, Exxol D130®, and Exxol D140® (each sold by Exxon Corporation); Teclen N-1 6®, Teclen N-20®, Teclen N-22®, Nisseki Naphthesol L®, Nisseki Naphthesol M®, Nisseki Naphthesol H®, Solvent L®, Solvent M®, Solvent H®, Nisseki lsosol 300®, Nisseki lsosol 400®, AF-4®, AF-5®, AF-6®, and AF-7®, (each sold by Nippon Oil Corporation), IP Solvent 1620®, and IP Solvent 2028® (each sold by Idemitsu Petrochemical co, ltd); Amsco OMS®, and Amsco 460® (each sold by American Mineral Spirits corp.); and electron, positron, new II, Purogen HF (100% synthetic terpenes) (sold by Ecolink).

In an embodiment, the carrier liquid is relatively non-viscous to allow movement of the particles during development, and sufficiently volatile to permit its timely removal from the final imaged substrate, but sufficiently non-volatile to minimize evaporative losses in the developer. In addition, the carrier liquid should be chemically inert with respect to the materials or equipment used in the printing process.

The ink composition comprises solid particles. Solid particles are part of the non volatile substances (NVS). In an embodiment of the present invention, the solid particles of the composition are dispersed in the carrier liquid and are present in the composition in a form of a dispersion. The term dispersion is used herein to denote a mixture, in which solid particles are scattered throughout a liquid. In another embodiment, such dispersions are stable such that the particle size distribution is maintained over long period of time, for instance, more than a year. The solid particles comprise pigments that are compounded in the resin particles. In an embodiment, the pigments are pigments that are coated to resin polymers. In other word, the pigments are physically compounded and/or embedded in resin polymers and might be considered as fillers in the resin solid compound. The words “compounded” and “embedded” refer to composites, herein to pigments and resin polymers, that have been is generated by a mechanical process such as milling or, more commonly, by extruder (compounder). Thus, in an embodiment, such solid particles are made by a mechanical process. In another embodiment, such solid particles are made by a grinding process which results in pigments that are compounded in resin polymers.

The solid particles for use in an embodiment of the present invention have an average particle size of less than about 10 μm. In another embodiment, the solid particles have an average particle size of less than about 5 μm; in another embodiment, the solid particles have an average particle size of less than about 1 μm. Size referrer herein are the diameter size of particles. Without being bound to any theory, it is believed that it is within this specific size and quantity that the ink compositions, according to embodiments of the present invention, have the optimum printing performances and involve less amount of ink in view of obtaining good printing results. In an embodiment, solid particles dispersed in the carrier liquid are tentacular solid particles.

In an embodiment of the present invention, the solid particles represent from about 60 wt % to about 99.5 wt % of total weigh weight of non volatile substances; in another embodiment, the solid particles represent from about 75 wt % to about 99 wt % of total weight of non volatile substances and, in another embodiment, the solid particles represent from about 80 wt % to about 95 wt % of total weight of non volatile substances present in the ink composition.

The solid particles, according to embodiment of the invention, comprise one or more pigments that impart the desired color to the printed message. In an embodiment, pigments are compounded in the resin polymers and are part of the solid particles. In an embodiment, the pigments are present in amounts representing from about 10 wt % to about 70 wt % of the total weight of solid particles. In another embodiment, the pigments are present in amounts representing from about 25 wt % to about 50 wt % of the total weight of solid particles. In another embodiment, the pigments are present in amounts representing from about 20 wt % to about 40 wt % of the total weight of solid particles. In another embodiment, the pigments are present in amounts representing about 25 wt % of the total weight of solid particles.

In an embodiment, the pigments can include, but are not limited to, cyan pigments, magenta pigments, yellow pigments, white pigments, black pigments, and any combinations thereof. In an embodiment, the pigments can include, but are not limited to, Helliogen Blue pigment 7080 (available from BASF), Helliogen Green pigment (available from BASF), Cyan pigment (available from Toyo). In an embodiment, the pigments can include, but are not limited to, optically variable pigments, thermochromic pigments, photochromic pigments, phosphorescent pigments, electroluminescent pigments, photoluminescent pigments, and combinations thereof. Non limiting examples of pigments are Mogul L (Cabot), Monastral Blue G (CI No. 74160), Toluidinc Red Y (CL Pigment Red 3), Quindo Magenta (Pigment Red 122), Dalamar Yellow (Pigment Yellow 74, C.I. No. 11741), Monastral Green B (CI. Pigment Green 7). In another embodiment, the pigments are organic pigments. In another embodiment, the pigments are organic black pigments. In an embodiment, pigments are dispersed in the resin particles down to the primary particle size of the pigment in larger resin particles.

In an embodiment, pigments are organic or inorganic particles as well known in the art. Suitable inorganic pigments include, for example, carbon black. However, other inorganic pigments may be suitable such as titanium oxide, cobalt blue (CoO—AI₂O₃), chrome yellow (PbCrO₄), and iron oxide. Suitable organic pigments include, for example, azo pigments including diazo pigments and monoazo pigments, polycyclic pigments (e.g., phthalocyanine pigments), insoluble dye chelates, nitropigments, nitroso pigments, and the like. Representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigment Red 202, Pigment Violet 19 and Pigment Violet 42. Representative examples of anthraquinones include Pigment Red 43, and Pigment Red 226. Representative examples of perylenes include Pigment Red 149 (Scarlet), Pigment Red 179, Pigment Red 190, Pigment Violet 19, and Pigment Red 224. Representative examples of heterocyclic yellows include Pigment Yellow 1, Pigment Yellow 3, Pigment Yellow 17, Pigment Yellow 65, Pigment Yellow 73, Pigment Yellow 74, Pigment Yellow 155, Pigment Yellow 83 and Pigment Yellow 138. Such pigments are commercially available in either powder or press cake form from a number of sources including, BASF Corporation, Engelhard Corporation and Sun Chemical Corporation. In an embodiment, examples of black pigments that are used include carbon pigments. The carbon pigment is any commercially available carbon pigment that provides acceptable optical density and print characteristics. Carbon pigments suitable for use in embodiments of the present invention include, without limitation, carbon black, graphite, vitreous carbon, charcoal, and combinations thereof. Such carbon pigments can be manufactured by a variety of known methods such as a channel method, a contact method, a furnace method, an acetylene method, or a thermal method, and are commercially available from such vendors as Cabot Corporation, Columbian Chemicals Company, Degussa AG, and E.I. DuPont de Nemours and Company. Suitable carbon black pigments include, without limitation, Cabot pigments such as Monarch 1400, Monarch 1100, CAB-O-JET 200, Black Pearls, and Vulcan pigments; Columbian pigments such as Raven 7000 and Raven 3500; Degussa pigments such as Color Black FW 200, Raven FW S170, Special Black 6, Special Black 5, Special Black 4, and Printex 140V; and Tipure R-available from Dupont and the like. Examples of other suitable colored pigments are described in the Colour Index, 3rd edition (The Society of Dyers and Colourists, 1982). The above list of pigments includes unmodified pigment particulates, small molecule attached pigment particulates, and polymer-dispersed pigment particulates. Other pigments not specifically listed can also be suitable for use within embodiments of the present invention.

The solid particles, according to embodiment of the invention, comprise resin polymers. In an embodiment, resin polymers are embedded with pigments and are part of the solid particles. In an embodiment, the resin polymers are present in amounts representing from about wt 30% to about 90 wt % of the total weight of solid particles. In another embodiment, the resin polymers are present in amounts representing from about 50 wt % to about 85 wt % of the total weight of solid particles; in another embodiment, in amounts representing from about 60 wt % to about 80 wt % of the total weight of solid particles. In another embodiment, the resin polymers are present in amounts representing about 75 wt % of the total weight of solid particles.

In an embodiment, resin polymers can include, but are not limited to, thermoplastic resins. In particular, in another embodiment, the resin polymers can include, but are not limited to, ethylene acid copolymers, ethylene acrylic acid copolymers, methacrylic acid copolymers, ethylene vinyl acetate copolymers, copolymers of ethylene, acrylic, or methacrylic acid and combinations thereof. In another embodiment, the resin polymers can include, but are not limited to, alkyl (C₁ to C₂₀) ester of methacrylic or acrylic acid; polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g.; copolymer of acrylic or methacrylic acid and at least one alkyl ester of acrylic or methacrylic acid wherein alkyl is from 1 to about 20 carbon atoms); ethylene-acrylate terpolymers: ethylene-acrylic esters-maleic anhydride (MAH) or glycidyl methacrylate (GMA) terpolymers; low molecular weight ethylene-acrylic acid ionomers and any combinations thereof

In an embodiment, the resin polymers can include, but are not limited to, the Nucrel family of resins (e.g., Nucrel 403®, Nucrel 407®, Nucrel 609HS®, Nucrel 908HS®, Nucrel 1202HC®, Nucrel 30707®, Nucrel 1214®, Nucrel 903®, Nucrel 3990®, Nucrel 910®, Nucrel 925®, Nucrel 699®, Nucrel 599®, Nucrel 960®, Nucrel RX 76®, Nucrel 2806®), Bynell 2002, Bynell 2014, and Bynell 2020 (sold by E. I. du PONT), the Aclyn family of resins (e.g. Aclyn 201 , Aclyn 246, Aclyn 285, and Aclyn 295), the Lotader family of resins (e.g. Lotader 2210, Lotader, 3430, and Lotader 8200) sold by Arkema.

In an embodiment of the invention, the resin polymer is a polymer blend which comprises two or more polymers. In an embodiment of the invention, the polymer blend is substantially insoluble in the carrier liquid and, at least, one of the polymers solvates the carrier liquid at an elevated temperature.

In an embodiment, the polymer material is reactive with a substrate on which it is printed. Thus, in an embodiment of the invention the polymers utilized include a minor proportion of a first polymer having a relatively greater reactive affinity for the paper and a major portion of a second polymer having substantially no reactive affinity or a relatively smaller reactive affinity of the paper. In an embodiment, the first polymer comprises between 2 and 40%, in an embodiment between 2 and 20% of the total amount of polymer in the solid particles. In another embodiment of the invention, the second polymer is a mixture of polymers.

In an embodiment of the invention, the first polymer has an anhydride functionality and forms a homogeneous mixture with the other polymers in the particles. The anhydride functionality is believed to form a bond, at the fixing temperature of about 70-90° C., with the cellulose in the paper. In particular, it is believed that the oxygen in the anhydride bonds with hydrogen in the cellulose. Thus, under high-speed printing conditions, the anhydride (or other material with a high affinity for paper) provides for adequate boding of the toner to the paper, despite the relatively shorter times available for transfer of the toner to the paper and for fusing it thereto. The first polymer may be in the form of a terpolymer containing an anhydride functionality, such as maleic anhydride terpolymer or it may be, for example, maleic anhydride grafted linear low-density polyethylene, maleic anhydride grafted polypropylene copolymer, maleic anhydride grafted linear ethylene acetate polymer. Other materials with anhydride functionality may also be used. Other minor portion polymers believed to work in a similar manner include polymers having an epoxy functionality. It is believed that when activated by water or hydroxyl functionalities in the paper, the epoxy functionality bonds with hydroxyl functionalities in the paper.

While the second polymer may include any polymer or mixture of polymers having suitable viscosity, solvation and other parameters for toner, some especially suitable first polymer materials include, ethylene methacrylic acid copolymers and their ionomers, ethylene acrylic acid copolymers and their ionomers, polyamides, etc., or mixtures thereof. In an embodiment of the invention, the proportion of the first polymer in the blend is between about 2% and about 10%, in another embodiment the proportion is about 5%. In another embodiment of the invention, the first polymer comprises a polymer having an anhydride functionality.

There is thus provided, in accordance with an embodiment of the invention, an ink composition, having a viscosity which is below about 50 cps, and having, at least, 10 wt % of total weight of ink composition of non volatile substances, and comprising: a carrier liquid, a dispersing agent and solid particles which are dispersed in the carrier liquid and wherein such solid particles comprise pigments embedded with a polymer blend. In an embodiment, such polymer blend comprises: a first polymer in the form of a terpolymer containing an anhydride functionality and a second polymer selected from the group including, ethylene methacrylic acid copolymers and their ionomers, ethylene acrylic acid copolymers and their ionomers, polyamides, or mixtures thereof.

The present ink composition contains a dispersing agent. In an embodiment of the present invention, the dispersing agents represent from about 0.5 wt % to about 40 wt % of total weight of non volatile substances; in another embodiment, the dispersing agents represent from about 1 wt % to about 25 wt % of total weight of non volatile substances present in the ink composition and, in another embodiment, the dispersing agents represent from about 5 wt % to about 20 wt % of total weight of non volatile substances present in the ink composition.

Suitable dispersing agents generally include molecules with a polar portion and a non-polar portion, such as the lithium, cadmium, calcium, manganese, magnesium and zinc salts of heptanoic acid; the barium, aluminum, cobalt, manganese, zinc, cerium and zirconium salts of 2-ethyl hexanoic acid, (these are known as metal octoates); the barium, aluminum, zinc, copper lead and iron salts of stearic acid; the calcium, copper, manganese, nickel, zinc and iron salts of naphthenic acid; and ammonium lauryl sulfate, sodium dihexyl sulfosuccinate, sodium dioctyl sulfosuccinate, aluminum diisopropyl salicylate, aluminum dresinate, aluminum salt of 3,5 di-t-butyl gamma resorcylic acid. Mixtures of these materials may also be used. In a embodiment, dispersing agents include lecithin (Fisher Inc.); OLOA-1200®, a polyisobutylene succinimide available from Chevron Chemical Company; basic barium petronate (Witco Inc.); zirconium octoate (Nuodex); aluminum stearate; salts of calcium, manganese, magnesium and zinc; heptanoic acid; salts of barium, aluminum, cobalt, manganese, zinc, cerium, and zirconium octoates; salts of barium, aluminum, zinc, copper, lead, and iron with stearic acid; iron naphthenate; acrylic copolymers, such as RCP 1257, available from E. I. Du Pont de Nemours and Co.; and the like, as well as mixtures thereof. In another embodiment, SP-11200® and SP-900®, both available from Lubrizol and OLOA-1200® available from Chevron are used as dispersing agent.

In an embodiment, several dispersing agents are used in the composition. In another embodiment, a dispersing agent and a co-dispersing agents are used in the ink composition. As co-dispersing agent it is meant herein a second dispersing agent which is different from the first dispersing agent. In another embodiment, OLOA 1200®, SP9000® or SP11200® are used as co-dispersants.

In an embodiment, various types of additives may be employed in the ink composition to optimize the properties of said ink composition. For example, the ink composition may also include any number of surface modifiers and any additional additives.

According to an embodiment of the present invention, ink compositions are made according to specific methods. Such method comprises the steps of, firstly, mixing a carrier liquid, a resin polymer and a pigment to form a slurry. In an embodiment, other components such as surface modifiers, dispersing agents and additives may be added to the slurry at this stage. Such mixture is then grinded in a, so-called, grinding step. In another embodiment, such method comprises the step of adding, at least, a dispersing agent and concentrating said composition in view of obtaining an ink composition comprising, at least, about 10 weight % of non volatile substances by weight of the ink composition.

In an embodiment, the method of producing an ink composition comprises the steps of: mixing a liquid carrier, a resin polymer and a pigment to form a slurry; grinding the slurry in view of obtaining a dispersion of solid particles comprising pigments embedded with resin polymers; adding at least a dispersing agent and further grinding said mixture; concentrating said composition in view of obtaining an ink composition comprising, at least, about 10 weight % of non volatile substances by weight of ink composition. In an embodiment, the method further comprises the step of adding a co-dispersant to the composition in view of stabilizing the composition. In an embodiment, the method of producing an ink composition comprises the steps of adding OLOA 1200® as dispersing agent, grinding the mixture and then adding the SP-11200® and SP-9000® as dispersing agent.

In an embodiment, as an example, the carrier liquid, dispersing agents, resin polymers and pigments are mixed in a mixer (e.g., double planetary mixer and the like). In an embodiment, as an example, the grinding step is made with a grinder e.g., an attritor, a disk mill, a sand mill, a ball mill, an impeller attrition mill, a vibro-energy mill, or the like; and ground for a period of time to form the ink composition. In another embodiment, the grinding step is made with a ball mill. In an embodiment, the resulting composition is concentrated in view of obtaining an amount of, about 10 weight % of non volatile substances by weight of the ink composition. In an embodiment, the above mentioned slurry is grinded for about 1 to about 5 hours, at a temperature of about 20° C. to about 70° C.; in another embodiment at a temperature of about 45° C. to about 65° C. In an embodiment, the temperature is flat through the whole grinding process. In an embodiment, revolutions per minute (RPM) range from about 50 to about 1000; in another embodiment, from about 200 to about 800 RPM. More generally, it can be said that the grinding time and the grinding speeds depend on the amount of the material to be grinded and also depend of the size of the tool that is used.

In another embodiment, the grinding step is made at a temperature of about 58° C. and at about 700 revolutions per minute (RPM). Without being bound to the theory, such hot grinding process, i.e. made at a temperature of about 45° C. to 65° C., enables the formation of symmetrical solid particles, i.e. solid particles in the form of spheres.

The milling process is carried out by some mechanical shear energy with or without the aid of milling media, such as zirconia or stainless steel balls. The grinding apparatus which can provide suitable mechanical shear energy include any of the conventional grinding equipment, including paint shakers, ball mills, Sweeco mills, attritors, sand mills, small media mills, homogenizers, micro-fluidizers, etc. The suitable grinding/milling media include table salt, glass beads, zirconia beads, ceramic beads, plastic beads, stainless steel beads, and the like. In another embodiment, the grinding step is made using a ball mill with zirconia beads as the grinding media.

The grinding step is maintained until the solid particle is dispersed and compounded in the resin polymers to form the desired mixture, i.e. solid particles comprising pigments embedded with resin polymers, and in order to achieve the desired particle size. In another embodiment, the grinding step is maintained in view of obtaining an ink composition having solid particle dispersed in a liquid medium wherein the particles are resin particles impregnated with pigments. In an embodiment, the grinding step is maintained until the solid particles are dispersed and reached the average particle size of less than about 10 μm; in another embodiment, of less than about 5μm and, in another embodiment, of less than about 1 μm. In an embodiment, the grinding step is maintained until the solid particles result in solid particles in the form of spheres. In another embodiment, the grinding step is maintained until the solid particles reach the average particle size of less than about 1 μm and result in solid particles in the form of spheres.

According to an embodiment of the present invention, the ink composition is an inkjet ink printing composition. In another embodiment, the ink composition is an inkjet ink printing composition adapted for use in an indirect inkjet printing system. In another embodiment, the ink composition is employable in an ink reservoir of an inkjet printing system. In another embodiment, the ink composition is employable in an ink reservoir of an inkjet printing system using intermediate transfer surface for printing.

In an embodiment of the present invention, the ink composition is used in methods for forming printed images on media substrates. Such method comprises the steps of projecting a stream of droplets of the ink composition onto a surface to form the desired printed image. The inkjet ink composition may be established on the substrate via any suitable inkjet printing technique. Non-limitative examples of such inkjet printing techniques include thermal, acoustic, and piezoelectric inkjet printing. In another embodiment, the composition is implemented into an inkjet printing machine, in which one or more inkjet printheads define the image to be printed by dispensing ink onto an intermediate transfer surface. In another embodiment, the intermediate transfer surface has the form of a drum or roller. In an embodiment of the present invention, the ink composition dries on the intermediate transfer surface in the form of an image. The intermediate transfer surface, then, contacts a final media sheet, i.e. the final media substrates, at which point the ink, in the pattern of the image, is transferred to the final media substrates. In an embodiment of the present invention, the composition is ideally suited for wide-format printing method.

Thus, in an embodiment of the present invention, the ink composition, having a viscosity which is below about 50 cps and having at least, 10 weight % of non volatile substances, and comprising a carrier liquid, a dispersing agent and dispersed solid particles, which contain pigments embedded with resin polymers, is used in inkjet printing device to form printing images on media substrates. Such method comprises the steps of jetting said composition, via inkjet printheads of inkjet printing device, onto an intermediate transfer surface and then, contacting the intermediate transfer surface with a final media in view of obtaining the desired printing image on such final media.

In an embodiment, the present disclosure also refers to a printed media substrate comprising a colored image produced by the use of, at least, an ink composition suitable for inkjet printing having a viscosity which is below about 50.0 cps and having, at least, 10 wt %, by total weight of ink composition, of non volatile substances, such composition comprising: carrier liquid, dispersing agent, and solid particles, which are dispersed in the carrier liquid and which comprise pigments embedded with resin polymers.

In an embodiment, it is believed that, within the high amount of non volatile substances in the composition (i.e. at least 10%), the quantity of liquid to be removed from the composition, prior to its transfer, is reduced. This results, thus, in an increased speed of the printing process. Therefore, the time available for transferring the image to the substrate is also decreased. Furthermore, within this specific concentration of solid particles, the composition enable the use of less amount of composition and the creation of thinner layers on intermediate transfer surface, while still resulting in the same benefit on the image to be printed.

In an embodiment of the present invention, the substrate or receiver media can be of any size. In another embodiment, the substrate (or media substrate) include any substrate that can be use in the inkjet printing arts, including, but in no way limiting to, resin coated papers (so-called photo-based papers), papers, overhead projector plastics, coated papers, fabrics, art papers (e.g. water color paper) and the like. The images are printed on porous and non-porous surface, using the ink composition of embodiments of the present invention. In another embodiment, the substrate (or media substrate) is paper (non-limitative examples of which include plain copy paper or papers having recycled fibers therein) or photo-paper (non-limitative examples of which include polyethylene or polypropylene extruded on one or both sides of paper), and/or combinations thereof. In an embodiment, the substrate has a thickness along substantially the entire length ranging between about 0.025 mm and about 0.5 mm.

As used herein, “images” refers to marks, signs, symbols, figures, indications, and/or appearances deposited upon a substrate with either visible or an invisible ink composition. Examples of an image can include characters, words, numbers, alpha-numeric symbols, punctuation, text, lines, underlines, highlights, and the like.

In another embodiment according to the present invention, the inks are utilized in an ink jet set comprising, at least, magenta, cyan, yellow and black inks.

To further illustrate embodiment(s) of the invention, various examples are given herein. It is to be understood that these are provided for illustrative purposes and are not to be construed as limiting the scope of the disclosed embodiment(s). In the examples below, unless otherwise indicated, all percentages (%) express weight percentages.

### EXAMPLE 1

### Preparation of Stock Precursor for the Ink Composition

As a first step, 600 grams of Nucrel-699® (an polyethylene methacrylic acid copolymer from DuPont) and 150 grams of AC-5120® (an ethylene acrylic acid copolymer available from Honeywell) are mixed in a Ross double planetary mixer with 1750 grams of Isopar-L® carrier liquid (an isoparaffinic hydrocarbon oil manufactured by Exxon) at a speed of 60 rpm and at a temperature of 130° C., for one hour. The temperature is then reduced and mixing is continued until the mixture reaches room temperature. During mixing, the polymer solvates carrier liquid (Isopar-L®) and during the cooling, granules of polymer (with solvated carrier liquid) in carrier liquid are produced. The result is an ink pasty material.

As a second step, the grinding step, per se, is done. 1500 grams of the mixture produced in the first step is charged into a S1 ball attritor (made by Union Process) together with 10 grams of aluminum tri-stearate (from Riedel de-Haan) and 65 grams of pigment blue 15:3 pigment (made by Toyo Ink), and with 700 grams of Isopar-L®. The mixture is ground for 12 hours at 58° C. until a ink composition containing dispersed solid particle comprising pigment compounded in the resin polymers is produced. The resulting composition is discharged from the attritor and mixed with carrier liquid (Isopar-L®) to form composition dispersion. The resulting composition (stock precursor) have a viscosity at 20% NVS of about 8000 cps, and have median particle size of about 5 microns.

### EXAMPLE 2

### Embodiment of Ink of Reduced Viscosity

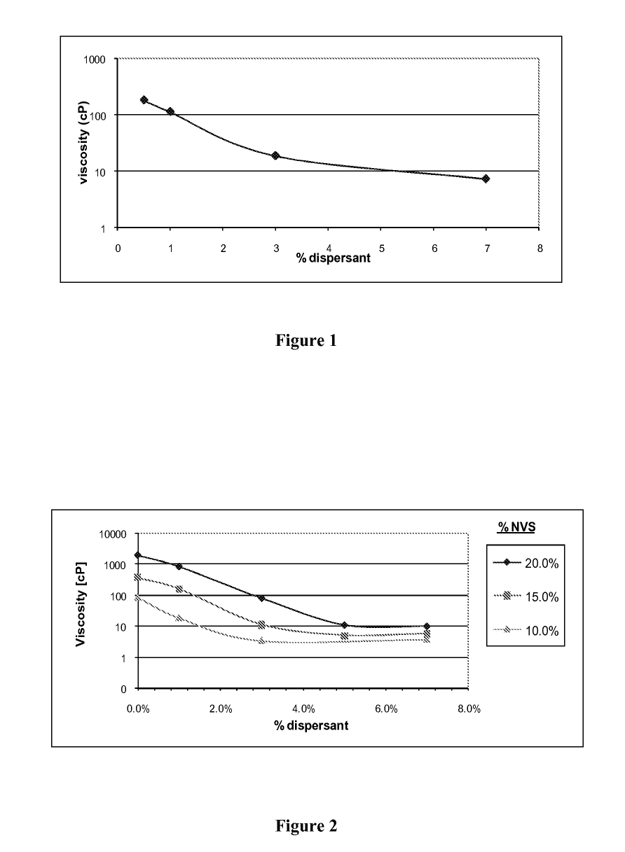

On the mixture obtained in example 1, there is a Gradual addition of dispersing agent (OLOA-1200® available from Chevron) using hand held high shear (Rotor/stator high-shear tool from IKA) for 30 min. This result in an ink composition which contains 14 wt % of NVS. The viscosity of the composition against the level of dispersing agent (OLOA-1200®) available from Chevron) is presented in the graph illustrated in FIG. 1. This graph demonstrate that the addition of 3.5 wt % of dispersing agent, by weight of the total ink composition, take the viscosity of the composition, containing 14 wt % of non volatile solvent, down to 10 cps. (3.5 wt % of dispersing agent, by weight of the total ink composition is equivalent to 25% dispersing agent.by weight of non volatile solvent).

### EXAMPLE 3

### Another Embodiment of Ink of Reduced Viscosity

On the mixture obtained in example 1, there is a Gradual addition of dispersing agent (Sp-9000® available from Lubrizol) using a hand held high shear (from IKA) in view of obtaining ink composition having around 10, 15 and 20 wt % of NVS. The viscosity of the composition against the level of dispersing agent (Sp-9000® available from Lubrizol) (% by weight of the total ink composition) is presented in the graph illustrated in FIG. 2. This graph illustrate that 5 wt % of dispersing agent (Sp-9000®), by weight of the total ink composition, take the viscosity of composition containing 10, 15 and 20 wt % of NVS down to 10 cps.

### EXAMPLE 4

In the mixture obtained according to example 1, 3 wt % of dispersing agent (Sp-11200® available from Lubrizol) (by weight of the total ink composition) is added to obtain a composition containing 12.4 wt % of NVS. 200 g. of this composition is therefore grounded in the Eiger mini-lab tool with 0.65 mm Zirconia media. The grinding process is carried at a temperature of about 40° C. for 3 hours. The resulting composition contains solid particles having average size of less than 0.5 μm. The resultant ink is gellated while standing non mixed over night. In order to concentrate and stabilize the ink formulation, 30 ml of such composition is then centrifuged at 4000 RPM for 40 min at 5° C. Liquid carrier (Isopar-L®) is extracted in view of obtaining composition having 20 wt % of NVS. 2 wt % of another dispersing agent (OLOA-1200®) (by weight of the total ink composition) is added to the composition followed by 5 minutes high-shear agitation to make the ink composition. The resulting composition is a stable ink composition having a viscosity at 30 cps, having 20 wt % non volatile substances (NVS) (by weight of the total ink composition) on the form of a dispersion and comprise, thus, about 80 wt % of carrier liquid, 5 wt % of dispersing agent and 15 wt % of solid particle comprising pigments embedded with resin polymers by weight of the total ink composition.

### Examples of Dispersing Agents

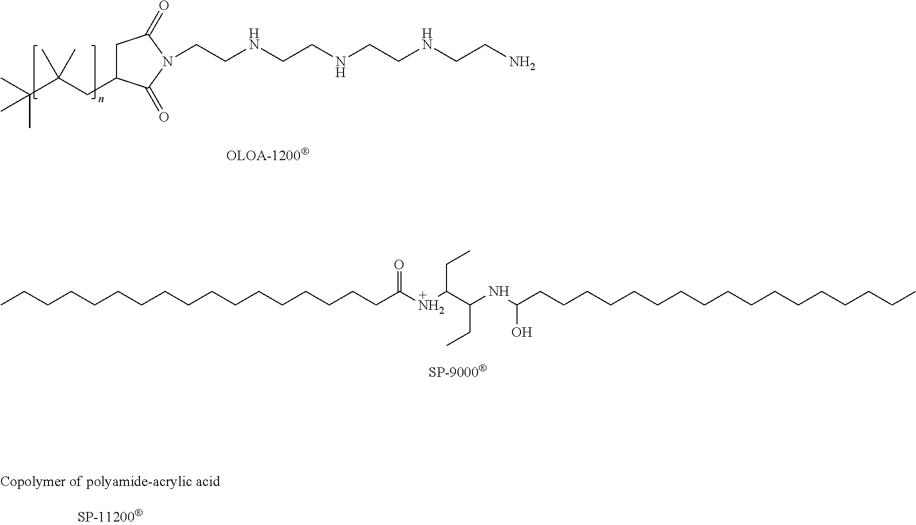

The preceding description has been presented only to illustrate and describe exemplary embodiments of the present disclosure. It is not intended to be exhaustive or to limit the system and method to any precise form disclosed. Many modifications and variations are possible in light of the above teaching. It is intended that the scope of the invention be defined by the following claims.

1. An ink composition having a viscosity which is below about 50.0 cps and having, at least, 10 wt %, by total weight of ink composition, of non volatile substances, such composition comprising:
a) carrier liquid,
b) dispersing agent,
c) and solid particles, which are dispersed in the carrier liquid and which comprise pigments embedded with resin polymers.

2. The composition according to claim 1 wherein the ink compositions is a non-aqueous inkjet ink composition.

3. The composition according to claim 1 wherein the ink composition has a viscosity within the range of from about 5 to about 25.0 cps.

4. The composition according to claim 1 wherein the solid particles represent from about 60 wt % to about 99.5 wt % of total weight of non volatile substances.

5. The composition according to claim 1 wherein solid particles comprise pigments that are present in amounts representing from about 10 wt % to about 70 wt % of total weight of solid particles.

6. The composition according to claim 1 wherein the average size of solid particles are less than 1 μm.

7. The composition according to claim 1 wherein solid particles comprise resin polymers selected from the group including ethylene acid copolymers, ethylene acrylic acid copolymers, methacrylic acid copolymers, ethylene vinyl acetate copolymers, copolymers of ethylene, acrylic, or methacrylic acid and any combinations thereof.

8. The composition according to claim 1 wherein solid particles comprise resin polymers which are polymer blend comprising two or more polymers and wherein the polymer blend comprises a first polymer in the form of a terpolymer containing an anhydride functionality and a second polymer selected from the group including, ethylene methacrylic acid copolymers and their ionomers, ethylene acrylic acid copolymers and their ionomers, polyamides, or mixtures thereof.

9. The composition according to claim 1 wherein the dispersing agent is present in an amount representing from about 0.5 wt % to about 40 wt % of the total weight of non volatile substances.

10. The composition according to claim 1 which further comprises a co-dispersing agent.

11. A method of producing an ink composition comprising the steps of:
a) mixing a liquid carrier, a resin polymer and a pigment to form a slurry;
b) grinding the slurry in view of obtaining a dispersion of solid particles comprising pigments embedded with resin polymers;
c) adding, at least, a dispersing agent and further grinding said mixture;
d) concentrating said composition in view of obtaining an ink composition comprising, at least, about 10 weight % of non volatile substances by weight of ink composition.

12. The method according to claim 11, wherein the grinding step is made, using a ball mill, at a temperature of about 45° C. to about 65° C.

13. The method according to claim 11, wherein the grinding step is maintained until the solid particles are dispersed in the carrier liquid and reached the average particle size of less than about 1 μm.

14. A method of use of ink composition to form printed images on media substrates, wherein the composition has a viscosity which is below about 50 cps, has, at least, 10 weight % of non volatile substances and comprises a carrier liquid, a dispersing agent and dispersed solid particles containing pigments embedded with resin polymers, and wherein such method comprises the steps of:
a. jetting said composition, via printheads of inkjet printing device, onto an intermediate transfer surface and then,
b. contacting the intermediate transfer surface with a final media substrates in view of obtaining the desired printing image on such substrate.

15. A printed media substrate comprising a colored image produced using, at least, the ink composition produced according to claim 1.
